(19) United States
(12) Patent Application Publication
(10) Pub. No.: US 2026/0361581 A1
(43) Pub. Date: Nov. 12, 2026

(54) SIGNAL TRANSMISSION METHOD AND APPARATUS, AND STORAGE MEDIUM

(71) Applicant: ZTE CORPORATION, Shenzhen, Guangdong (CN)

(72) Inventors: Yu XIN, Shenzhen (CN); Tong BAO, Shenzhen (CN)

(21) Appl. No.: 19/121,662

(22) PCT Filed: Nov. 10, 2023
(86) PCT No.: PCT/CN2023/131092

§ 371 Date: Apr. 16, 2025

(30) Foreign Application Priority Data
Mar. 23, 2023 (CN) 202310356423.6

(51) Int. Cl. H04L 27/26; H04L 5/00

(52) U.S. Cl. CPC H04L 27/261; H04L 5/0005; H04L 27/26025

(57) ABSTRACT

The present disclosure provides a signal transmission method and apparatus, and a storage medium. The method includes: transmitting a signal on a time slot, where the time slot includes N symbols, the N symbols include R reference signal symbols and D data symbols, a length of each reference signal symbol of H reference signal symbols among the R reference signal symbols is less than a length of each data symbol of the D data symbols, N is a positive integer, R and D are both positive integers less than N, and H is a positive integer less than or equal to R.

### CROSS-REFERENCE TO RELATED APPLICATION(S)

The present disclosure is a national phase entry under 35 USC 371 of International Patent Application No. PCT/CN2023/131092 filed on 10 Nov. 2023, the International Patent Application is filed based on Chinese Patent Application with the application No. 202310356423.6, filed on Mar. 23, 2023, and claims priority to the Chinese Patent Application, the entire contents of the International Patent Application and the Chinese Patent Application are incorporated herein by reference.

### TECHNICAL FIELD

The present disclosure relates to the field of communication technologies, and in particular to a signal transmission method, a signal transmission apparatus, and a storage medium.

### BACKGROUND

Different radio channel scenarios are supported in the fifth-generation mobile communication technology (5th generation wireless systems, 5G) new radio (New Radio, NR). In order to meet requirements, the related standard specifies the configuration of a flexible demodulation reference signal.

### SUMMARY

In an aspect, the embodiments of the present disclosure provide a signal transmission method. The signal transmission method includes: transmitting a signal on a time slot, where the time slot includes N symbols, the N symbols include R reference signal symbols and D data symbols, a length of each reference signal symbol of H reference signal symbols among the R reference signal symbols is less than a length of each data symbol of the D data symbols, N is a positive integer, R and D are both positive integers less than N, and H is a positive integer less than or equal to R.

In another aspect, the embodiments of the present disclosure provide a signal transmission apparatus. The signal transmission apparatus includes: a communication module, configured to transmit a signal in a time slot, where the time slot includes N symbols, the N symbols include R reference signal symbols and D data symbols, a length of each reference signal symbol of H reference signal symbols among the R reference signal symbols is less than a length of each data symbol of the D data symbols, N is a positive integer, R and D are both positive integers less than N, and H is a positive integer less than or equal to R.

In another aspect, the embodiments of the present disclosure provide a communication apparatus. The communication apparatus includes a memory and a processor; the memory is coupled with the processor; the memory is configured to store computer program instructions executable by the processor; and the processor, when executing the computer program instructions, implements the signal transmission method in any aspect mentioned above.

In another aspect, the embodiments of the present disclosure provide a computer-readable storage medium, where computer program instructions are stored on the computer-readable storage medium, and when the computer program instructions are executed on a computer (e.g., a communication apparatus or a signal transmission apparatus), the signal transmission method in any aspect mentioned above is implemented.

In another aspect, the embodiments of the present disclosure provide a computer program product, where the computer program product includes computer program instructions, and when the computer program instructions are executed, the signal transmission method in any aspect mentioned above is implemented.

### BRIEF DESCRIPTION OF THE DRAWINGS

FIG. 1 is a structural schematic diagram of a radio frame according to some embodiments.

FIG. 2 is a schematic diagram of an architecture of a communication system according to some embodiments.

FIG. 3 is a flowchart of a signal transmission method according to some embodiments.

FIG. 4 is a structural schematic diagram of a time slot configuration according to some embodiments.

FIG. 5 is a structural schematic diagram of another time slot configuration according to some embodiments.

FIG. 6 is a structural schematic diagram of yet another time slot configuration according to some embodiments.

FIG. 7 is a structural schematic diagram of yet another time slot configuration according to some embodiments.

FIG. 8 is a diagram of a time-frequency resource according to some embodiments.

FIG. 9 is a diagram of another time-frequency resource according to some embodiments.

FIG. 10 is a diagram of yet another time-frequency resource according to some embodiments.

FIG. 11 is a diagram of yet another time-frequency resource according to some embodiments.

FIG. 12 is a diagram of yet another time-frequency resource according to some embodiments.

FIG. 13 is a structural schematic diagram of yet another time slot configuration according to some embodiments.

FIG. 14 is a structural schematic diagram of yet another time slot configuration according to some embodiments.

FIG. 15 is a flowchart of another signal transmission method according to some embodiments.

FIG. 16 is a flowchart schematic diagram of waveform modulation according to some embodiments.

FIG. 17 is a schematic diagram of a signal transmission apparatus according to some embodiments.

FIG. 18 is a structural schematic diagram of a communication apparatus according to some embodiments.

### DETAILED DESCRIPTION

In order to make those skilled in the art better understand technical solutions of the embodiments of the present disclosure, the technical solutions of the embodiments of the present disclosure will be clearly and completely described in conjunction with the drawings in the embodiments of the present disclosure. Obviously, the described embodiments are only some of the embodiments of the present disclosure, not all of the embodiments. All other embodiments obtained based on the embodiments in the present disclosure by those ordinary skilled in the art without making creative efforts fall within the protection scope of the embodiments of the present disclosure.

In the description of the present disclosure, unless otherwise stated, the character “/” means “or”, and for example, A/B may represent A or B. “And/or” herein only describes an associated relationship of associated objects, representing that there may be three relationships, and for example, A and/or B may represent: only A, only B, and A and B. In addition, “at least one” means one or more, and “a/the plurality of/multiple” means two or more. The expressions “first”, “second” or the like do not limit the quantity and the order of execution, and the expressions “first”, “second” or the like are not necessarily different.

It should be noted that in the present disclosure, the word “for example” or “exemplarily”, etc., is used to represent an example, an illustration or an explanation. Any embodiment or design scheme described with “exemplarily” or “for example” in the present disclosure should not be interpreted as more preferred or advantageous than other embodiments or design schemes. Specifically, the use of the words such as “exemplarily” or “for example”, etc., is intended to present related concepts in detail.

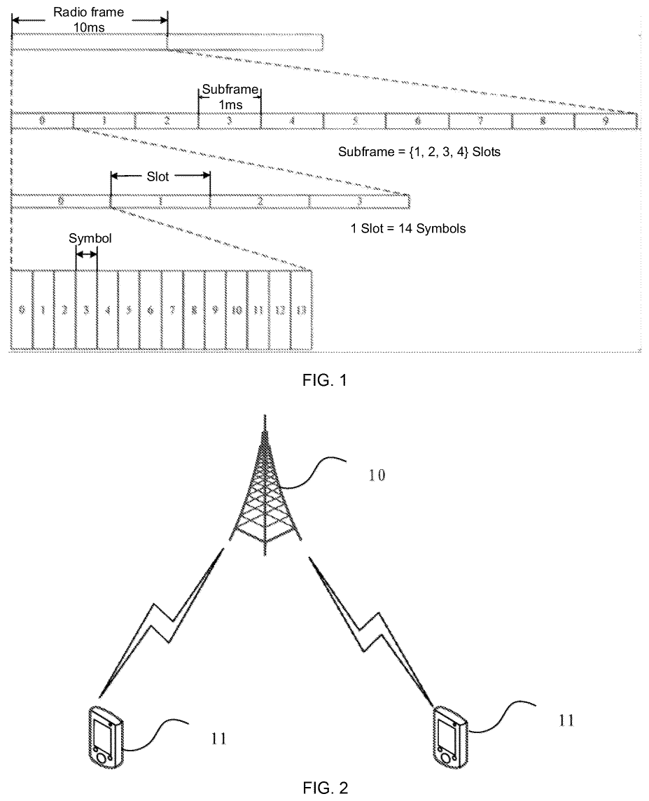

Referring to FIG. 1, a radio frame in NR is 10 milliseconds (ms), and the radio frame may be divided into 10 subframes, and each subframe is 1 ms. Each subframe includes multiple time slots, and each time slot is composed of 14 orthogonal frequency division multiplexing (OFDM) symbols (under a normal cycle prefix).

A main principle of OFDM is to: divide a channel into multiple orthogonal sub-channels, convert a high-speed data signal into parallel low-speed sub-data flows, and modulate the parallel low-speed sub-dataflows onto each sub-channel for a transmission. An orthogonal signal may be separated by using some techniques at a receiving end, so that mutual interference between the sub-channels may be reduced. A signal bandwidth on each sub-channel is smaller than the related bandwidth of the channel, thus, each sub-channel may be considered as experiencing flat fading, so that inter-symbol interference may be eliminated, and because the bandwidth of each sub-channel is only a small part of the original channel bandwidth, the channel equalization becomes relatively easy.

An OFDM symbol duration includes valid symbol time and cyclic prefix time. The valid symbol time depends on a subcarrier spacing.

The cyclic prefix (CP) is formed by copying a signal at the tail of the OFDM symbol to the header of the OFDM symbol. There are two kinds of lengths of CP mainly as follows: a normal cyclic prefix and an extended cyclic prefix. A length of the normal cyclic prefix is less than a length of the extended cyclic prefix. The cyclic prefix may be associated with other multi-path component information, to obtain complete information. In addition, the cyclic prefix may enable pre-estimation of time and frequency synchronization.

In some techniques, lengths of OFDM symbols within a time slot are the same. In this way, there are a large number of reference signal symbols configured in a time slot, which leads to the low spectrum efficiency of the system. In this regard, the embodiments of the present disclosure reduce the lengths of some or all of the reference signal symbols within the time slot, to ensure that even if the number of reference signal symbols configured within the time slot is large, it will not occupy excessive spectrum resources, thereby ensuring the spectrum efficiency of the system.

The technical solutions provided by the embodiments of the present disclosure may be applied to various communication systems, such as a new radio (New Radio, NR) communication system using the 5G communication technology, a future evolution system, or a multi-communication fusion system, etc.

Exemplarily, FIG. 2 is a schematic diagram of an architecture of a communication system according to some embodiments. The communication system may include a base station 10 and one or more terminals 11, and the base station 10 may perform the communication connection with the one or more terminals 11.

The base station 10 may be used to implement functions such as resource scheduling, radio resource management and radio access control of the terminals, etc. For example, the base station may be any node such as a small base station, a radio access point, a transceiver point (transmission receive point, TRP), a transmission point (TP), and some other access node.

The terminal 11 may also be referred to as a terminal device, a user equipment, a mobile station, a mobile terminal, or the like. Exemplarily, the terminal may be a mobile phone, a tablet computer, a computer with a wireless transceiver function, a virtual reality terminal, an augmented reality terminal, a wireless terminal in industrial control, a wireless terminal in autonomous driving, a wireless terminal in remote surgery, a wireless terminal in transportation safety, a wireless terminal in smart cities, a wireless terminal in smart homes, etc. The embodiments of the present disclosure do not limit the device form used by the terminal.

It should be noted that FIG. 2 is only an exemplary frame diagram, the number of devices included in FIG. 2 and the names of the respective devices are not limited thereto, and the communication system may also include other devices, such as a core network device, in addition to the devices shown in FIG. 2.

The application scenarios of the embodiments of the present disclosure are not limited. The system architecture and traffic scenario described in the embodiments of the present disclosure are used to more clearly explain the technical solutions of the embodiments of the present disclosure, and do not constitute a limitation on the technical solutions provided by the embodiments of the present disclosure. Those ordinary skilled in the art may know that with the evolution of the network architecture and the emergence of new traffic scenarios, the technical solutions provided by the embodiments of the present disclosure are also applicable to similar technical problems.

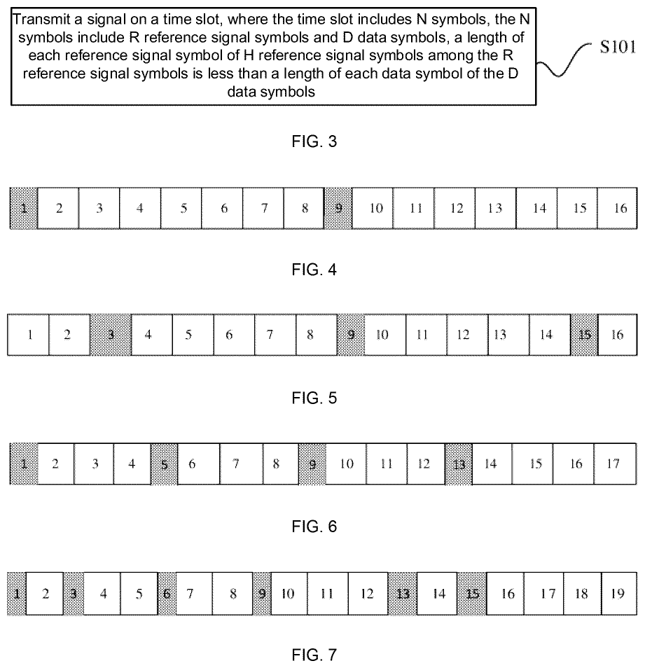

The embodiments of the present disclosure provide a signal transmission method, which is applicable to a communication node, and the communication node may be the base station 10 or the terminal 11 in FIG. 2, which is not limited in the embodiments of the present disclosure. As shown in FIG. 3, the method includes S101.
S101, transmit a signal on a time slot, where the time slot includes N symbols, the N symbols include R reference signal symbols and D data symbols, a length of each reference signal symbol of H reference signal symbols among the R reference signal symbols is less than a length of each data symbol of the D data symbols. N is a positive integer, R and D are both positive integers less than N, H is a positive integer less than or equal to R, and N=R+D.

The reference signal symbol is a time domain symbol used to carry a reference signal. In an example, an entire frequency domain unit occupied by the reference signal symbol carries the reference signal. In another example, a part of the frequency domain unit on the reference signal symbol is used to carry the reference signal, and another part of the frequency domain unit is used to carry data or is empty. Exemplarily, the reference signal includes at least one of a demodulation reference signal, a sounding reference signal, and a channel state information reference signal, which is not limited thereto.

The data symbols are other symbols in the time slot except the reference signal symbols, and the data symbols are mainly used to carry data.

In some embodiments, in a case where the symbols in the time slot have the normal cyclic prefix, a time slot may include 14 time domain symbols, i.e., N=14. Alternatively, in a case where the symbols in the time slot do not have the normal cyclic prefix, a time slot may include 15 time domain symbols, i.e., N=15. Exemplarily, the time domain symbol may be an OFDM symbol, which is not limited thereto.

In some embodiments, the OFDM symbol position occupied by the reference signal symbol in the time slot may be configured according to a channel state.

In some embodiments, the length of the time slot in the embodiments of the present disclosure may be the same as the length of the time slot in the related standard, to ensure good compatibility with the related standard.

In some embodiments, a length of each reference signal symbol of other reference signal symbols among the R reference signal symbols except the H reference signal symbols is equal to the length of the data symbol.

In some embodiments, lengths of the H reference signal symbols are the same. Alternatively, lengths of at least two reference signal symbols of the H reference signal symbols are not the same.

In some embodiments, the length of each data symbol is an even multiple of the length of each reference signal symbol of the H reference signal symbols. For example, the length of the data symbol is 2 multiples of the length of each reference signal symbol of the H reference signal symbols. In an example, the length of the data symbol is a power-of-two multiple of the length of the reference signal symbol.

In an example, lengths of the H reference signal symbols are the same, the length of the data symbol is 2ⁿ multiples of the length of each reference signal symbol of the H reference signal symbols, n is a positive integer and H is equal to 2ⁿ.

Exemplarily, as shown in FIG. 4, the symbols in the time slot do not include the normal cyclic prefix, and 16 OFDM symbols are configured for the time slot. The 16 OFDM symbols include 2 reference signal symbols and 14 data symbols, and the 2 reference signal symbols occupy a first OFDM symbol and a ninth OFDM symbol, respectively. The 14 data symbols occupy a 2nd OFDM symbol to an 8th OFDM symbol and a 10th OFDM symbol to a 16th OFDM symbol, respectively. The length of the data symbol is 2 multiples of the length of each reference signal symbol of the 2 reference signal symbols.

Exemplarily, as shown in FIG. 5, the symbols in the time slot do not include the normal cyclic prefix, and 16 OFDM symbols are configured for the time slot. The 16 OFDM symbols include 3 reference signal symbols and 13 data symbols. The 3 reference signal symbols occupy a 3rd OFDM symbol, a 9th OFDM symbol, and a 15th OFDM symbol, respectively. The 14 data symbols occupy a 1st OFDM symbol to a 2nd OFDM symbol, a 4th OFDM symbol to an 8th OFDM symbol, and a 10th OFDM symbol to a 14th OFDM symbol, respectively. The length of the data symbol is equal to the length of the reference signal symbol occupying the 3rd OFDM symbol. The length of the data symbol is 2 multiples of the length of each reference signal symbol of the reference signal symbols occupying the 9th OFDM symbol and the 15th OFDM symbol.

As another example, lengths of at least two reference signal symbols of the H reference signal symbols are not the same, the length of the data symbol is 2ⁿ multiples of the length of each reference signal symbol of 2ⁿ reference signal symbols among the H reference signal symbols, and the length of the data symbol is 2^{m} multiples of the length of each reference signal symbol of 2^{m} reference signal symbols among the H reference signal symbols, H is equal to a sum of 2ⁿ and 2^{m}, and n and m are both positive integers.

Exemplarily, as shown in FIG. 7, the symbols in the time slot do not include the normal cyclic prefix, and 19 OFDM symbols are configured for the time slot. The 19 OFDM symbols include 6 reference signal symbols and 13 data symbols. The 6 reference signal symbols occupy a 1st OFDM symbol, a 3rd OFDM symbol, a 6th OFDM symbol, a 9th OFDM symbol, a 13th OFDM symbol and a 15th OFDM symbol, respectively. The 13 data symbols occupy a 2nd OFDM symbol, a 4th OFDM symbol, a 5th OFDM symbol, a 7th OFDM symbol, an 8th OFDM symbol, a 10^{th} OFDM symbol to a 12th OFDM symbol, a 14th OFDM symbol, and a 16th OFDM symbol to a 19th OFDM symbol, respectively. The length of the data symbol is 4 multiples of the length of each reference signal symbol of the reference signal symbols occupying the 1st OFDM symbol, the 3rd OFDM symbol, the 6th OFDM symbol, and the 9th OFDM symbol. The length of the data symbol is 2 multiples of the length of each reference signal symbol of the reference signal symbols occupying the 13th OFDM symbol and the 15th OFDM symbol.

In some embodiments, a length of a first reference signal symbol in the time slot is the same as the length of the data symbol.

In some embodiments, a first symbol in the time slot is a reference signal symbol. This facilitates the receiving end to discover the time slot in time, and receive data transmitted by the time slot. Exemplarily, continuing to refer to FIG. 4, the symbols in the time slot do not contain the normal cyclic prefix, 16 OFDM symbols are configured for the time slot. The 16 OFDM symbols include 2 reference signal symbols and 14 data symbols, and the 2 reference signal symbols occupy the 1st OFDM symbol and the 9th OFDM symbol, respectively. The 14 data symbols occupy the 2nd OFDM symbol to the 8th OFDM symbol and the 10th OFDM symbol to the 16th OFDM symbol, respectively. The length of the data symbol is 2 multiples of the length of each reference signal symbol of the 2 reference signal symbols. The first symbol in the time slot is the reference signal symbol.

In some embodiments, the R reference signal symbols are non-continuous symbols on a time domain. In this way, the reference value of the reference signal symbols may be ensured.

Exemplarily, continuing to refer to FIG. 6, the symbols in the time slot do not include the normal cyclic prefix, 17 OFDM symbols are configured for the time slot. The 17 OFDM symbols include 4 reference signal symbols and 13 data symbols. The 4 reference signal symbols are non-continuous symbols on a time domain, occupying a 1st OFDM symbol, a 5th OFDM symbol, a 9th OFDM symbol, and a 13th OFDM symbol, respectively.

In some embodiments, among the R reference signal symbols, R1 reference signal symbols are continuous symbols on the time domain, and R2 reference signal symbols are non-continuous symbols on the time domain, where R=R1+R2, and R1 and R2 are positive integers less than R.

In some embodiments, a subcarrier spacing of each reference signal symbol of the H reference signal symbols is equal to a subcarrier spacing of each data symbol of the D data symbols. As an example, the reference signal occupies non-continuous subcarriers on the frequency domain corresponding to the H reference signal symbols. For example, the reference signal occupies even or odd subcarriers on the frequency domain corresponding to the H reference signal symbols, to save spectrum resources.

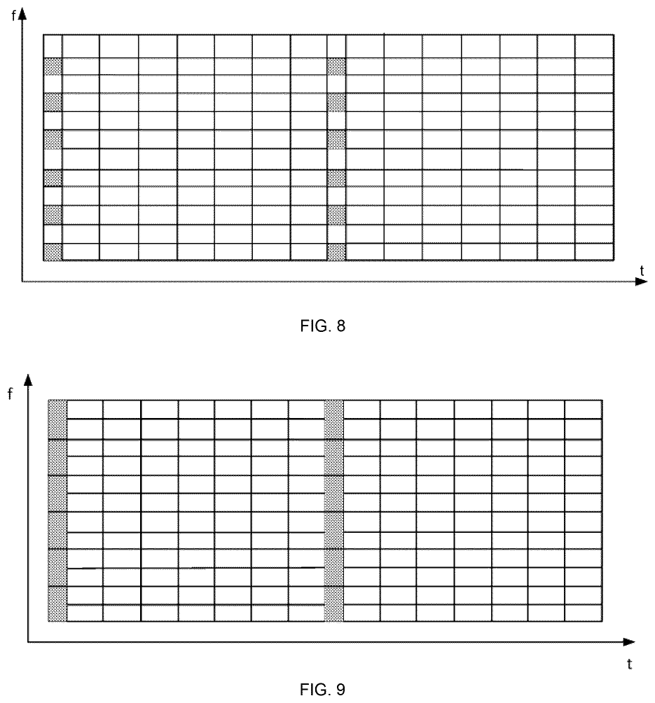

Exemplarily, referring to the time-frequency resource diagram shown in FIG. 8, the resource block size is 1 RB, the symbols in the time slot do not include the normal cyclic prefix, and 16 OFDM symbols are configured for the time slot. The 16 OFDM symbols include 2 reference signal symbols and 14 data symbols. The subcarrier spacings of the 2 reference signal symbols are equal to the subcarrier spacings of the data symbols. Non-continuous subcarriers are occupied on the frequency domain corresponding to the 2 reference signal symbols.

In some embodiments, the subcarrier spacing of each reference signal symbol of the H reference signal symbols is larger than the subcarrier spacing of the data symbol. That is, for the H reference signal symbols, the subcarrier spacings may be negatively correlated with the length of the reference signal symbol.

In some embodiments, a subcarrier spacing of each reference signal symbol of other reference signal symbols among the R reference signal symbols except the H reference signal symbols is equal to the subcarrier spacing of the data symbol.

In some embodiments, the subcarrier spacing of each reference signal symbol of the H reference signal symbols is an even multiple of the subcarrier spacing of the data symbol.

Exemplarily, subcarrier spacings of the H reference signal symbols are the same, the subcarrier spacing of each reference signal symbol of the H reference signal symbols is 2ⁿ multiples of the subcarrier spacing of the data symbol, n is a positive integer, and H is an integer multiple of 2ⁿ.

Exemplarily, referring to the time-frequency resource diagram shown in FIG. 9, the resource block size is 1 RB, the symbols in the time slot do not include the normal cyclic prefix, and 16 OFDM symbols are configured for the time slot. The 16 OFDM symbols include 2 reference signal symbols and 14 data symbols. The 2 reference signal symbols occupy a 1st OFDM and a 9th OFDM symbol, respectively. The 14 data symbols occupy a 2nd OFDM symbol to an 8th OFDM symbol and a 10th OFDM symbol to a 16th OFDM symbol, respectively. Subcarrier spacings of the two reference signal symbols are the same, and the subcarrier spacings of the reference signal symbols are 2 multiples of the subcarrier spacings of the data symbols. The lengths of the 2 reference signal symbols are the same, and the length of the reference signal symbol is half the length of the data symbol. The reference signal symbols and the data symbols occupy all subcarriers in the 1 RB, the 2 reference signal symbols occupy 6 subcarriers on the frequency domain, and 14 data symbols occupy 12 subcarriers on the frequency domain.

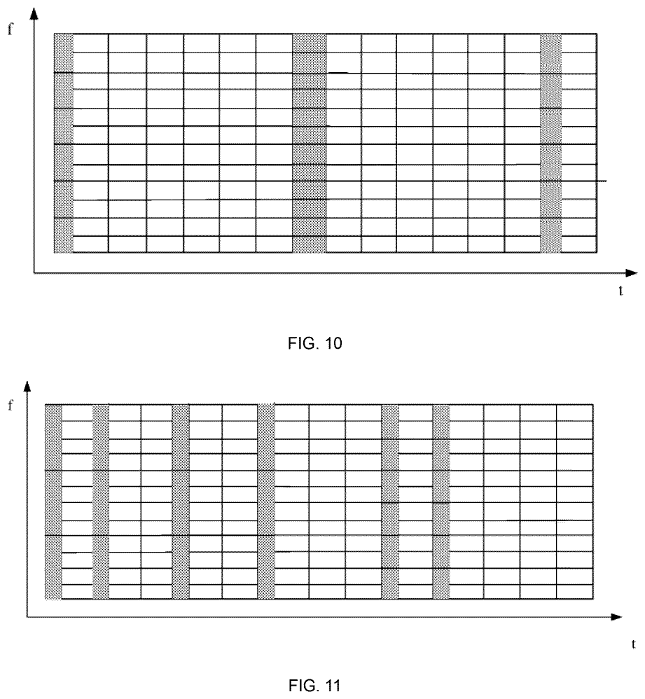

Exemplarily, referring to the time-frequency resource diagram shown in FIG. 10, the resource block size is 1 RB, the symbols in the time slot do not include the normal cyclic prefix, and 16 OFDM symbols are configured for the time slot. The 16 OFDM symbols include 3 reference signal symbols and 13 data symbols. The 3 reference signal symbols occupy a 1st OFDM symbol, 18th OFDM symbol, and a 15th OFDM symbol, respectively. The 14 data symbols occupy a 2nd OFDM symbol to a 7th OFDM symbol, a 9th OFDM symbol to a 14th OFDM symbol, and a 16th OFDM symbol, respectively. The subcarrier spacings of the reference signal symbols occupying the 1st OFDM symbol and the 15th OFDM symbol are 2 multiples of the subcarrier spacings of the data symbols. The subcarrier spacing of the reference signal symbol occupying the 8th OFDM symbol is equal to the subcarrier spacing of the data symbol. The lengths of the reference signal symbols occupying the 1st OFDM symbol and the 15th OFDM symbol are half the length of the data symbol. The length of the reference signal symbol occupying the 8th OFDM symbol is equal to the length of the data symbol.

For another example, subcarrier spacings of at least two reference signal symbols of the H reference signal symbols are not the same. A subcarrier spacing of each reference signal symbol of 2ⁿ reference signal symbols among the H reference signal symbols is 2ⁿ multiples of the subcarrier spacing of the data symbol, and a subcarrier spacing of each reference signal symbol of 2^{m} reference signal symbols among the H reference signal symbol is 2^{m} multiples of the subcarrier spacing of the data symbol, H is equal to a sum of 2ⁿ and 2^{m}, n and m are both positive integers.

Exemplarily, referring to the time-frequency resource diagram shown in FIG. 11, the resource block size is 1 RB, the symbols in the time slot do not include the normal cyclic prefix, and 19 OFDM symbols are configured for the time slot. The 19 OFDM symbols include 6 reference signal symbols and 13 data symbols. The 6 reference signal symbols occupy a 1st OFDM symbol, a 3rd OFDM symbol, a 6th OFDM symbol, a 9th OFDM symbol, a 13th OFDM symbol and a 15th OFDM symbol, respectively. The 13 data symbols occupy a 2nd OFDM symbol, a 4th OFDM symbol, a 5th OFDM symbol, a 7th OFDM symbol, an 8th OFDM symbol, a 10th OFDM symbol to a 12th OFDM symbol, a 14th OFDM symbol, and a 16th OFDM symbol to a 19th OFDM symbol, respectively. Subcarrier spacings of the reference signal symbols occupying the 1st OFDM symbol, the 3rd OFDM symbol, the 6th OFDM symbol and the 9th OFDM symbol are 4 multiples of the subcarrier spacings of the data symbols. Subcarrier spacings of the reference signal symbols occupying the 13th OFDM symbol and the 15th OFDM symbol is 2 multiples of the subcarrier spacings of the data symbols.

In some embodiments, the reference signals occupy continuous subcarriers on a frequency domain corresponding to some or all of the R reference signal symbols.

In some embodiments, reference signals occupy non-continuous subcarriers on a frequency domain corresponding to some or all of the R reference signal symbols. In this way, the reference signals may occupy a part of the subcarriers, and the data signals may occupy another part of the subcarriers, so it may be ensured that more data can be transmitted while increasing the reference signals.

Exemplarily, subcarrier spacings at odd positions are occupied on the frequency domain corresponding to some or all of the R reference signal symbols; or subcarrier spacings at even positions are occupied on the frequency domain corresponding to some or all of the R reference signal symbols.

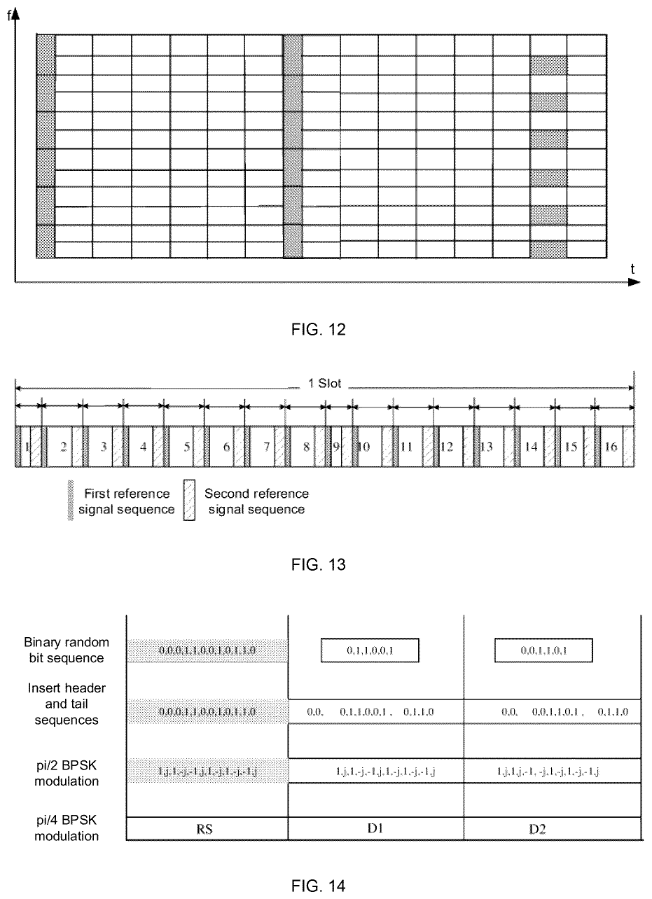

Referring to FIG. 12, the symbols in the time slot do not include the normal cyclic prefix, and 16 OFDM symbols are configured for the time slot. The 16 OFDM symbols include 3 reference signal symbols and 13 data symbols. The 3 reference signal symbols occupy a 1st OFDM symbol, an 8th OFDM symbol, and a 15th OFDM symbol, respectively. Continuous subcarrier spacings are occupied on the frequency domain corresponding to the reference signal symbols occupying the 1st OFDM symbol and the 8th OFDM symbol. Subcarrier spacings at odd positions are occupied on the frequency domain corresponding to the reference signal symbol occupying the 15th OFDM symbol. Subcarrier spacings at even positions may be used to transmit data symbols or other information.

In some embodiments, first reference signal sequences exist in headers of the N symbols, and/or second reference signal sequences exist in tails of the N symbols.

In some embodiments, the first reference signal sequences of the headers of the N symbols are the same, and/or the second reference signal sequences of the tails of the N symbols are the same. In this way, it serves to a function as a cyclic prefix, to counteract the multi-path delay, and the receiving end may also use a simple frequency domain equalization algorithm.

Exemplarily, referring to FIG. 13, the symbols in the time slot do not include the normal cyclic prefix, and 16 OFDM symbols are configured for the time slot. The 16 OFDM symbols include 2 reference signal symbols and 14 data symbols, and the 2 reference signal symbols occupy a 1st OFDM symbol and a 9th OFDM symbol, respectively. The 14 data symbols occupy a 2nd OFDM symbol to an 8th OFDM symbol and a 10 OFDM symbol to a 16th OFDM symbol, respectively. The first reference signal sequences of the headers of the 16 OFDM symbols are the same, and the second reference signal sequences of the tails of the 16 symbols are the same.

Exemplarily, the first reference signal sequences and the second reference signal sequences are binary sequences, or sequences processed from the binary sequences. For example, the first reference signal sequences and the second reference signal sequences may be sequences processed by modulation, rotation, interpolation, or the like for binary sequences.

Referring to FIG. 14, there are 3 OFDM symbols, which are 1 reference signal symbol (RS) and 2 data symbols (D), the total length of the reference signal symbol and the data symbols are 24, the total length of the data symbols is 12, the total length of the header reference signal sequences in the data symbols is 4, and the total length of the tail reference signal sequences in the data symbols is 8.

First, according to the lengths of the reference signal symbol and the data symbols, for the length of the header reference signal sequence and the length of the tail reference signal sequence inserted into the data symbol, a group of binary random bit sequences is generated: d=[(0, 0, 0, 1, 1, 0, 0, 1, 0, 1, 1, 0), (0, 1, 1, 0, 0, 1), (0, 0, 1, 1, 0, 1)].

Then, the header reference signal sequence and the tail reference signal sequence of the reference signal symbol are copied, to insert into positions of the header reference signal sequence and the tail reference signal sequence of the data symbol, and in this case, a group of binary random bit sequences is: d1=[(0, 0, 0, 1, 1, 0, 0, 1, 0, 1, 1, 0), (0, 0, 0, 1, 1, 0, 0, 1, 0, 1, 1, 0), (0, 0, 0, 0, 1, 1, 0, 1, 0, 1, 1, 0)].

In some embodiments, the sequence of the R reference signal symbols is at least one of a Zadoff Chu (ZC) sequence, a pi/2 (π/2) binary phase shift keying (BPSK) sequence, and a sequence transformed from the pi/2 BPSK sequence. The sequence transformed from the pi/2 BPSK sequence includes the π/4 BPSK sequence. In this way, it may be ensured that the symbols have a lower peak to average power ratio (PAPR).

In some embodiments, a modulation scheme of the R reference signal symbols is the same as a modulation scheme of the D data symbols, and for example, either pi/2 BPSK modulation or pi/4 BPSK modulation is used. This may enable the same modulation scheme for each symbol in the time slot, thereby ensuring that the symbols have a low PAPR and power spectral density (PSD).

A mapping rule satisfied by the pi/2 BPSK modulation process is that: a bit 0 at an odd position is mapped to 1, a bit 1 at an odd position is mapped to −1, a bit 0 at an even position is mapped to j, and a bit 1 at an even position is mapped to −j.

Continuing to refer to FIG. 14, the symbols by using pi/2 BPSK modulation are: [(1, j, 1, −j, −1, j, 1, −j, 1, −j, −1, j), (1, j, 1, −j, −1, j, 1, −j, 1, −j, −1, j), (1, j, 1, j, −1, −j, 1, −j, 1, −j, −1, j)].

A mapping rule satisfied by the pi/4 BPSK modulation process is that: a new modulation symbol is inserted between every two adjacent pi/2 BPSK modulation symbols, and the new modulation symbol is determined according to a sum of the two pi/2 BPSK modulation symbols adjacent to the new modulation symbol.

Continuing to refer to FIG. 14, the new modulation symbol is obtained by multiplying the sum of the two pi/2 BPSK modulation symbols adjacent to the new modulation symbol by a preset value, assuming that the preset value is a, for example,

$$a = \frac{√ 2}{2} .$$

Then, the pi/4 BPSK modulation symbols are: [RS, D1, D2]=[RS=[1, a(1+j), j, a(1+j), 1, a(1−j), −j, a(−1−j), −1, a(−1+j), j, a(1+j), 1, a(1−j), −j, a(1−j), 1, a(1−j), −j, a(−1−j), −1, a(−1+j), j, a(1+j)]; D1=[1, a(1+j), j, a(1+j), 1, a(1−j), j, a(−1−j), −1, a(−1+j), j, a(1+j), 1, a(1−j), −j, a(1−j), 1, a(1−j), −j, a(−1−j), −1, a(−1+j), j, a(1+j)]; D2=[1, a(1+j), j, a(1+j), 1, a(1+j), j, a(−1+j), −1, a(−1−j), −j, a(1−j), 1, a(1−j), −j, a(1−j), 1, a(1−j), −j, a(−1−j), −1, a(−1+j), j]].

In some embodiments, the length of the data symbol is equal to a length of a fast Fourier transform FFT window. The Fourier transform (fast Fourier transform, FFT) is used to analyze deterministic stationary signals. The FFT window is divided into the time domain and the frequency domain, the time domain is a mobile window, for smoothing the input time series. The frequency domain is a fixed window, for cutting off the high frequency and the low frequency.

In some embodiments, the length of the data symbol is equal to Ts, which is a reciprocal of the subcarrier spacing, and in a case where the length of the data symbol is equal to the length of a fast FFT window, if the length of each reference signal symbol of the H reference signal symbols is Ts/2, which is half of the reciprocal of the subcarrier spacing, the length of each reference signal symbol of the H reference signal symbols is equal to the length of half of the fast FFT window.

In some embodiments, in a case where the length of the data symbol is equal to a length of a fast Fourier transform FFT window and the length of the data symbol is 2ⁿ of the length of the reference signal symbol, the length of the reference signal symbol is equal to the length of ½ⁿ fast Fourier transform FFT window. In this way, the length of the FFT window is used to cut out the data symbol and the length of the ½ⁿ FFT window is used to cut out the reference signal symbol, directly.

In some embodiments, data to be transmitted of each symbol in the time slot, through discrete Fourier transformation, then resource mapping on the frequency domain, and then oversampled inverse discrete Fourier transform, and finally digital-to-analog conversion, etc., is transmitted on the radio frequency link.

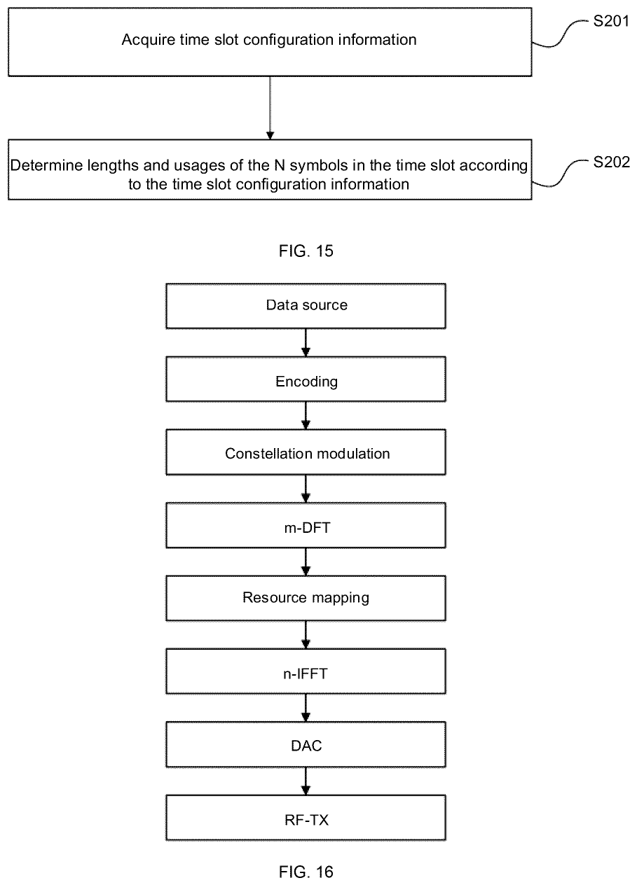

FIG. 15 is a flowchart of another signal transmission method according to some embodiments. As shown in FIG. 15, the method includes S201 and S202.
S201, acquire time slot configuration information.

The time slot configuration information is used to indicate at least one of: a value of N, a value of R, a value of D, a value of H, lengths of H reference signal symbols, and subcarrier spacings of the H reference signal symbols.
S202, determine lengths and usages of the N symbols in the time slot according to the time slot configuration information.

In some embodiments, the time slot configuration information is transmitted by a radio resource control (RRC) signaling, a control channel, or a traffic channel.

In some embodiments, the time slot configuration information may be carried in control information in a specific format. The format of the control information may be a format of control information transmitted by a downlink control channel or an uplink control channel. Alternatively, the format of the control information may be a format of control information transmitted by a downlink RRC signaling or an uplink RRC signaling.

In this way, the communication node may determine configurations of the respective symbols in the time slot according to the time slot configuration information.

Exemplarily, FIG. 16 is a flowchart schematic diagram of waveform modulation according to some embodiments. As shown in FIG. 16, a group of binary bit data sequences is acquired from a data source, the group of binary bit data sequences is encoded and undergoes constellation modulation, to obtain the modulated data symbol. The constellation modulation process includes inserting a header sequence and a tail sequence into the group of binary bit data sequences; the modulated data symbol is then subjected to Fourier transform (discrete fourier transformation, DFT), resource mapping, adding zero-data subcarriers, to achieve the oversampled inverse fast Fourier transform (inverse fast fourier transform, IFFT), to obtain time domain data, which is then subjected to digital-to-analog conversion (DAC), and so on, and transmitted on the radio frequency link (radio frequency transmit, RF-TX). The DFT used in the waveform modulation process may be m-point DFT and the used IFFT may be n-point IFFT, where n is greater than m.

The above introduces the solutions of the embodiments of the present disclosure mainly from the perspective of the methods. A signal transmission apparatus is also illustrated below, for performing the signal transmission method in any of the above embodiments and implementations thereof. It can be understood that the signal transmission apparatus includes the corresponding hardware structures and/or software modules for performing the respective functions, to implement the signal transmission method; and those skilled in the art should easily recognize that the present disclosure can be implemented in the form of hardware or a combination of hardware and computer software, in conjunction with the algorithmic steps of the respective examples described in the embodiments of the present disclosure. Whether a certain function is performed by hardware or computer software-driven hardware depends on the specific application and design constraints of the technical solutions. Professional technicians may use different methods to implement the described functions, for each specific application, but such an implementation should not be considered beyond the scope of the present disclosure.

In the embodiments of the present disclosure, the signal transmission apparatus may be divided into functional modules according to the above-mentioned method embodiments, and for example, each functional module may be divided corresponding to each function, or two or more functions may be integrated into one functional module. The above-mentioned integrated module may be implemented in the form of hardware or may be implemented in the form of software. It should be noted that the division of modules in the embodiments of the present disclosure is illustrative, and is merely a kind of logical functional division, and there may be other division methods in actual implementations. The example in which a functional module may be divided corresponding to each function is taken for explanation below.

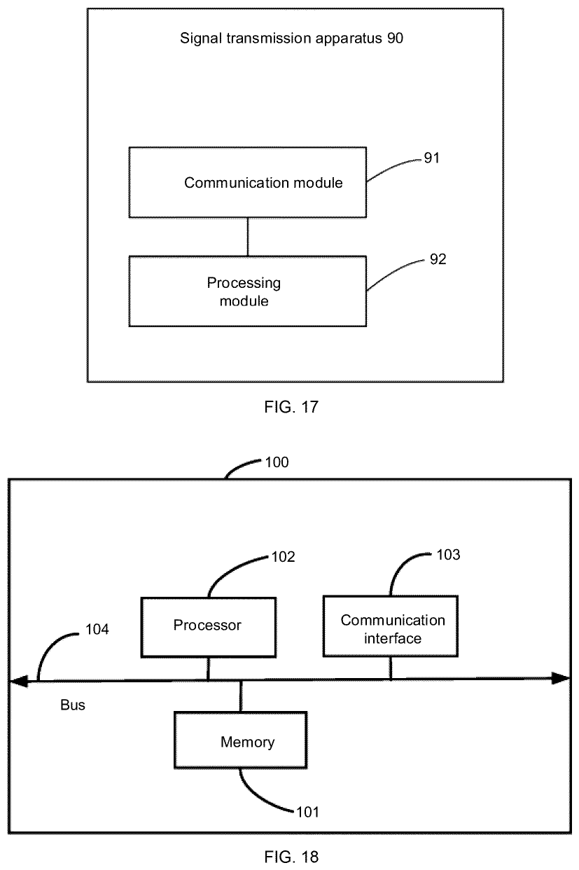

FIG. 17 illustrates a signal transmission apparatus according to some embodiments. The signal transmission apparatus 90 includes: a communication module 91 and a processing module 92.

The communication module 91 is configured to transmit a signal on a time slot, where the time slot includes N symbols, the N symbols include R reference signal symbols and D data symbols, a length of each reference signal symbol of H reference signal symbols among the R reference signal symbols is less than a length of each data symbol of the data symbols, N is a positive integer, R and D are both positive integers less than N, and H is a positive integer less than or equal to R.

In some embodiments, a length of each reference signal symbol of other reference signal symbols among the R reference signal symbols except the H reference signal symbols is equal to the length of the data symbol.

In some embodiments, the length of the data symbol is an even multiple of the length of each reference signal symbol of the H reference signal symbols.

In some embodiments, the length of the data symbol is 2ⁿ multiples of the length of each reference signal symbol of the H reference signal symbols, n is a positive integer, and H is equal to 2ⁿ.

In some embodiments, lengths of at least two reference signal symbols of the H reference signal symbols are not same.

In some embodiments, the length of the data symbol is 2ⁿ multiples of a length of each reference signal symbol of 2ⁿ reference signal symbols among the H reference signal symbols, and the length of the data symbol is 2^{m} multiples of a length of each reference signal symbol of 2^{m} reference signal symbols among the H reference signal symbols, H is equal to a sum of 2ⁿ and 2^{m}, and n and m are both positive integers.

In some embodiments, a length of a first reference signal symbol in the time slot is the same as the length of the data symbol.

In some embodiments, a first symbol in the time slot is a reference signal symbol.

In some embodiments, the R reference signal symbols are non-continuous symbols on a time domain.

In some embodiments, a subcarrier spacing of each reference signal symbol of the H reference signal symbols is equal to a subcarrier spacing of each data symbol of the D data symbols.

In some embodiments, non-continuous subcarriers are occupied on a frequency domain corresponding to the H reference signal symbols.

In some embodiments, a subcarrier spacing of each reference signal symbol of the H reference signal symbols is greater than the subcarrier spacing of the data symbol.

In some embodiments, a subcarrier spacing of each reference signal symbol of other reference signal symbols among the R reference signal symbols except the H reference signal symbols is equal to the subcarrier spacing of the data symbol.

In some embodiments, the subcarrier spacing of each reference signal symbol of the H reference signal symbols is an even multiple of the subcarrier spacing of the data symbol.

In some embodiments, the subcarrier spacing of each reference signal symbol of the H reference signal symbols is 2ⁿ multiples of the subcarrier spacing of the data symbol, n is a positive integer, and H is an integer multiple of 2ⁿ.

In some embodiments, subcarrier spacings of at least two reference signal symbols of the H reference signal symbols are not same.

In some embodiments, a subcarrier spacing of each reference signal symbol of 2ⁿ reference signal symbols among the H reference signal symbols is 2ⁿ multiples of the subcarrier spacing of the data symbol, and a subcarrier spacing of each reference signal symbol of 2^{m} reference signal symbols among the H reference signal symbol is 2^{m} multiples of the subcarrier spacing of the data symbol, H is equal to a sum of 2ⁿ and 2^{m}, n and m are both positive integers.

In some embodiments, a reference signal occupies non-continuous subcarriers on a frequency domain corresponding to some or all of the R reference signal symbols.

In some embodiments, a reference signal occupies continuous subcarriers on a frequency domain corresponding to some or all of the R reference signal symbols.

In some embodiments, a sequence of the R reference signal symbols is at least one of a ZC sequence, a pi/2 BPSK sequence, and a sequence transformed from a pi/2 BPSK sequence.

In some embodiments, a modulation scheme of the R reference signal symbols is the same as a modulation scheme of the D data symbols.

In some embodiments, first reference signal sequences exist in headers of the N symbols, and/or second reference signal sequences exist in tails of the N symbols.

In some embodiments, the first reference signal sequences of the headers of the N symbols are same, and/or the second reference signal sequences of the tails of the N symbols are same.

In some embodiments, the first reference signal sequences and the second reference signal sequences are binary sequences, or sequences processed from the binary sequences.

In some embodiments, the length of the data symbol is equal to a length of a fast Fourier transform (FFT) window.

In some embodiments, the communication module 91 is further configured to acquire time slot configuration information.

In some embodiments, the signal transmission apparatus 90 further includes a processing module 92. The processing module 92 is configured to determine lengths and usages of the N symbols in the time slot according to the time slot configuration information.

In some embodiments, the time slot configuration information is used to indicate at least one of:
a value of the N;
a value of the R;
a value of the D;
a value of the H;
lengths of the H reference signal symbols; or
subcarrier spacings of the H reference signal symbols.

In some embodiments, the time slot configuration information is transmitted by a radio resource control (RRC) signaling, a control channel, or a traffic channel.

In a case of implementing the functions of the integrated modules mentioned above in the form of hardware, the embodiments of the present disclosure further provide a structure of a communication apparatus, and the communication apparatus is configured to perform the signal transmission method provided by the embodiments of the present disclosure. As shown in FIG. 18, the communication apparatus 100 includes a communication interface 103, a processor 102, a memory 101, and a bus 104.

The processor 102 may implement or perform various exemplary logical blocks, modules and circuits described in conjunction with the embodiments of the present disclosure. The processor 102 may be a central processing unit, a general-purpose processor, a digital signal processor, an application specific integrated circuit, a field programmable gate array or other programmable logic devices, a transistor logic device, a hardware component or any combination thereof. The processor 102 may implement or perform various exemplary logical blocks, modules and circuits described in conjunction with the embodiments of the present disclosure. The processor 102 may also be a combination that implements computing functions, for example, including a combination of one or more microprocessors, a combination of a digital signal processor (DSP) and a microprocessor, or the like.

The communication interface 103 is configured to connect with other devices via a communication network. The communication network may be an Ethernet, a radio access network, a wireless local area network (WLAN), or the like.

The memory 101 may be, but be not limited to, a read-only memory (ROM) or other types of static storage devices capable of storing static information and instructions, a random access memory (RAM) or other types of dynamic storage devices capable of storing information and instructions, or may also be an electrically erasable programmable read-only memory (EEPROM), a magnetic disk storage medium or other magnetic storage devices, or any other medium capable of being used to carry or store the desired program codes in the form of instructions or data structures and capable of being accessed by a computer.

As an implementation, the memory 101 may exist independently of the processor 102, and the memory 101 may be connected to the processor 102 via the bus 104 and is used for storing instructions or program codes. The processor 102, when calling and executing the instructions or program codes stored in the memory 101, is capable of implementing the signal transmission method provided by the embodiments of the present disclosure.

In another implementation, the memory 101 may also be integrated with the processor 102.

The bus 104 may be an extended industry standard architecture (EISA) bus or the like. Buses 104 may be divided into address buses, data buses, control buses, and the like. For the convenience of representation, only one thick line is used in FIG. 18 for representation, but it does not mean that there is only one bus or one type of bus.

Some embodiments of the present disclosure provide a computer-readable storage medium (e.g., a non-transitory computer-readable storage medium), and the computer-readable storage medium has stored computer program instructions therein that, when running on a computer, cause the computer to perform the signal transmission method as described in any of the above-mentioned embodiments.

In some implementations, the computer may be the above-mentioned signal transmission apparatus, and the embodiments of the present disclosure do not limit the form of the computer.

In some further examples, the above-mentioned computer-readable storage medium may include, but be not limited to, a magnetic storage device (e.g., a hard disk, a floppy disk or a magnetic tape, etc.), an optical disk (e.g., a Compact Disk (CD) or a Digital Versatile Disk (DVD), etc.), a smart card and a flash memory device (e.g., an Erasable Programmable Read-Only Memory (EPROM), a card, a stick or a key driver, etc.). The various computer-readable storage medium described in the present disclosure may represent one or more devices and/or other machine-readable storage media for storing information. The term “machine-readable storage medium” may include, but be not limited to, a radio channel and various other media capable of storing, containing, and/or carrying instructions and/or data.

The embodiments of the present disclosure provide a computer program product including instructions, and the computer program product, when running on a computer, causes the computer to perform the signal transmission method as described in any of the above-mentioned embodiments.

The foregoing is only the specific embodiments of the present disclosure, but the protection scope of the present disclosure is not limited thereto, and any changes or substitutions within the scope of the technologies disclosed in the present disclosure should be covered within the protection scope of the present disclosure. Therefore, the protection scope of the present disclosure should be determined based on the protection scope of claims.

What is claim is:

1. A signal transmission method, comprising:
transmitting a signal on a time slot, wherein the time slot comprises N symbols, the N symbols comprise R reference signal symbols and D data symbols, a length of each reference signal symbol of H reference signal symbols among the R reference signal symbols is less than a length of each data symbol of the D data symbols, N is a positive integer, R and D are both positive integers less than N, and H is a positive integer less than or equal to R.

2. The method according to claim 1, wherein a length of each reference signal symbol of other reference signal symbols among the R reference signal symbols except the H reference signal symbols is equal to the length of the data symbol; or
the length of the data symbol is an even multiple of the length of each reference signal symbol of the H reference signal symbols.

3. (canceled)

4. The method according to claim 2, wherein the length of the data symbol is 2ⁿ multiples of the length of each reference signal symbol of the H reference signal symbols, n is a positive integer, and H is equal to 2ⁿ.

5. The method according to claim 2, wherein lengths of at least two reference signal symbols of the H reference signal symbols are not same; and
the length of the data symbol is 2ⁿ multiples of a length of each reference signal symbol of 2ⁿ reference signal symbols among the H reference signal symbols, and the length of the data symbol is 2^{m} multiples of a length of each reference signal symbol of 2^{m} reference signal symbols among the H reference signal symbols, H is equal to a sum of 2ⁿ and 2^{m}, and n and m are both positive integers.

6. (canceled)

7. The method according to claim 1, wherein a length of a first reference signal symbol in the time slot is the same as the length of the data symbol; or
a first symbol in the time slot is a reference signal symbol.

8. (canceled)

9. The method according to claim 1, wherein the R reference signal symbols are non-continuous symbols on a time domain.

10. The method according to claim 1, wherein a subcarrier spacing of each reference signal symbol of the H reference signal symbols is equal to a subcarrier spacing of each data symbol of the D data symbols.

11. The method according to claim 10, wherein non-continuous subcarriers are occupied on a frequency domain corresponding to the H reference signal symbols.

12. The method according to claim 1, wherein a subcarrier spacing of each reference signal symbol of the H reference signal symbols is greater than a subcarrier spacing of each data symbol of the D data symbols, and a subcarrier spacing of each reference signal symbol of other reference signal symbols among the R reference signal symbols except the H reference signal symbols is equal to the subcarrier spacing of the data symbol; or
the subcarrier spacing of each reference signal symbol of the H reference signal symbols is an even multiple of the subcarrier spacing of the data symbol.

13. (canceled)

14. (canceled)

15. The method according to claim 12, wherein the subcarrier spacing of each reference signal symbol of the H reference signal symbols is 2ⁿ multiples of the subcarrier spacing of the data symbol, n is a positive integer, and H is an integer multiple of 2ⁿ.

16. The method according to claim 12, wherein subcarrier spacings of at least two reference signal symbols of the H reference signal symbols are not same; and
a subcarrier spacing of each reference signal symbol of 2ⁿ reference signal symbols among the H reference signal symbols is 2ⁿ multiples of the subcarrier spacing of the data symbol, and a subcarrier spacing of each reference signal symbol of 2^{m} reference signal symbols among the H reference signal symbol is 2^{m} multiples of the subcarrier spacing of the data symbol, H is equal to a sum of 2ⁿ and 2^{m}, n and m are both positive integers.

17. (canceled)

18. The method according to claim 1, wherein a reference signal occupies non-continuous subcarriers on a frequency domain corresponding to some or all of the R reference signal symbols; or
a reference signal occupies continuous subcarriers on a frequency domain corresponding to some or all of the R reference signal symbols.

19. (canceled)

20. The method according to claim 1, wherein a sequence of the R reference signal symbols is at least one of a Zadoff Chu (ZC) sequence, a pi/2 binary phase shift keying (BPSK) sequence, and a sequence transformed from a pi/2 BPSK sequence; or
a modulation scheme of the R reference signal symbols is the same as a modulation scheme of the D data symbols.

21. (canceled)

22. The method according to claim 1, wherein first reference signal sequences exist in headers of the N symbols, and/or second reference signal sequences exist in tails of the N symbols.

23. The method according to claim 22, wherein the first reference signal sequences of the headers of the N symbols are same, and/or the second reference signal sequences of the tails of the N symbols are same; or
the first reference signal sequences and the second reference signal sequences are binary sequences, or sequences processed from the binary sequences.

24. (canceled)

25. The method according to claim 1, wherein the length of the data symbol is equal to a length of a fast Fourier transform (FFT) window.

26. The method according to claim 1, further comprising:
acquiring time slot configuration information; and
determining lengths and usages of the N symbols in the time slot according to the time slot configuration information.

27. The method according to claim 26, wherein the time slot configuration information is used to indicate at least one of:
a value of the N;
a value of the R;
a value of the D;
a value of the H;
lengths of the H reference signal symbols; or
subcarrier spacings of the H reference signal symbols; and
wherein the time slot configuration information is transmitted by a radio resource control (RRC) signaling, a control channel, or a traffic channel.

28. (canceled)

29. A communication apparatus, comprising a memory and a processor; wherein the memory is coupled with the processor, the memory is configured to store a computer program, and the processor, when executing the computer program, implements:
transmitting a signal on a time slot, wherein the time slot comprises N symbols, the N symbols comprise R reference signal symbols and D data symbols, a length of each reference signal symbol of H reference signal symbols among the R reference signal symbols is less than a length of each data symbol of the D data symbols, N is a positive integer, R and D are both positive integers less than N, and H is a positive integer less than or equal to R.

30. A non-transitory computer-readable storage medium, wherein computer instructions are stored on the computer-readable storage medium, and the computer instructions, when being executed on a communication apparatus, cause the communication apparatus to perform the signal transmission method according to claim 1.
